(19) United States
(12) Patent Application Publication
(10) Pub. No.: US 2008/0036320 A1
(43) Pub. Date: Feb. 14, 2008

(54) Motor with air bearing structure

(75) Inventors: Sean Chang, Taoyuan Hsien (TW); Chii-How Chang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/889,017

(22) Filed: Aug. 8, 2007

(30) Foreign Application Priority Data
Aug. 14, 2006 (TW) 095129722

(51) Int. Cl. H02K 7/08

(52) U.S. Cl. 310/90

(57) ABSTRACT

A motor with an air bearing structure includes a shaft, a rotor, a stator and a magnetic body. The rotor is coupled to the shaft and an air gap is formed therebetween, thereby forming the air bearing structure. The stator is coupled to the rotor and an air gap is formed therebetween. The magnetic body is disposed adjacent to the periphery of the stator.

### CROSS REFERENCE TO RELATED APPLICATIONS

This Non-provisional application claims priority under 35 U.S.C. §119(a) on Patent Application No. 095129722 filed in Taiwan, Republic of China on Aug. 14, 2006, the entire contents of which are hereby incorporated by reference.

### BACKGROUND OF THE INVENTION

1. Field of Invention

The invention relates to a motor and in particular, to a motor with an air bearing structure.

2. Related Art

In present days, electronic products have been made smaller, and motors are more important than usual, especially the high speed motors. Accordingly, the relative techniques are developed rapidly. As the speed of the motor has been increased, the bearing and shaft must be manufactured with highly precise fitness, low friction coefficient, low vibration and longer product life. Air bearings can satisfy these requirements.

To solve the problems of vibration and excess swing of the motor, the conventional air bearing is provided with grooves on an inner wall thereof to balance the pressure between the shaft and the inner wall of the bearing when the shaft rotates so that the shaft can be stabilized. In this case, the grooves are manufactured by an electrical discharge machining technique, which utilizes a fine electrode as one electrode with a processed workpiece as the other electrode. An electrical discharge occurs in a fine gap between these two electrodes. In this process, thermal actions such as ionization, melting and evaporation, and physical actions such as discharge and explosive force, are induced. At the same time, the workpiece is rotated and moved, so that it can be processed like a milling process. Alternatively, the grooves can be formed by a chemical etching process. However, the conventional ways of manufacturing the grooves are time waste, complex and expensive, and need high precision in manufacturing.

Therefore, it is an important subject to provide a motor with an air bearing structure, which can solve the above mentioned problems by reducing the vibration of the air bearing structure so as to increase the reliability and product life of the motor.

### SUMMARY OF THE INVENTION

In view of the foregoing, the invention is to provide a motor with an air bearing structure. When rotating, the motor is more stabile and has less vibration since the distribution of partial magnetic filed is changed. Therefore, the reliability of the motor can be increased.

To achieve the above, the motor of the invention includes a shaft, a rotor, and a stator. The rotor is coupled to the shaft so that an air gap is formed therebetween to form the air bearing structure. The stator is coupled to the shaft and is located on a periphery of the rotor. The stator has a plurality of coils disposed therearound and has a magnetic body for changing a magnetic torque between the stator and the rotor. When the motor is operating, the rotor is forced by the magnetic torque and biased slightly toward the magnetic body so that the magnetic field distribution inside the motor can be changed. Therefore, the air gap between the shaft and the rotor at a place farther away the magnetic body is a little narrower than that near the magnetic body. That is, the air gap between the shaft and the rotor is non-uniform. Such a non-uniform air gap can reduce the vibration of the shaft when the rotor is rotating. Therefore, the conventional groove is not necessary in the motor of the invention.

As mentioned above, the non-uniform air gap can be performed by disposing a permanent magnet or a yoke close to the air bearing structure, changing the winding numbers of the coils of the stator, or decreasing the area of the iron ring of the stator so that the magnetic field can be changed. Thus, the air gap is non-uniform while the air bearing structure rotates so as to reduce the vibration of the shaft. Compared with the prior art, the invention utilizes the magnetic body to change the distribution of the magnetic field in the motor for stabilizing the shaft. In other words, it is unnecessary to process the shaft to form the conventional grooves. As a result, the air bearing structure of the invention can rotate stably so as to increase the reliability and lifetime of the motor.

### BRIEF DESCRIPTION OF THE DRAWINGS

The invention will become more fully understood from the subsequent detailed description and the accompanying drawings, which are given by way of illustration only, and thus are not limitative of the present invention, and wherein:

FIG. 1 is a schematic diagram of a motor with an air bearing structure according to a first embodiment of the invention;

FIG. 2 is a schematic diagram of a motor with an air bearing structure according to a second embodiment of the invention;

FIG. 3 is a schematic diagram of a motor with an air bearing structure according to a third embodiment of the invention;

FIG. 4 is a schematic diagram of a motor with an air bearing structure according to a fourth embodiment of the invention;

FIG. 5 and FIG. 6 are schematic diagrams of a motor with an air bearing structure according to a fifth embodiment of the invention;

FIG. 7 and FIG. 8 are schematic diagrams of a motor with an air bearing structure according to a sixth embodiment of the invention;

FIG. 9 is a schematic diagram of a motor with an air bearing structure according to a seventh embodiment of the invention; and

FIG. 10 is a schematic diagram of a motor with an air bearing structure according to an eighth embodiment of the invention.

### DETAILED DESCRIPTION OF THE INVENTION

The present invention will be apparent from the following detailed description, which proceeds with reference to the accompanying drawings, wherein the same references relate to the same elements.

In all of the drawings, (A) part represents a top view of the motor, (B) part represents a sectional view along X-X line of (A) part, and (C) part represents a lateral view of the motor.

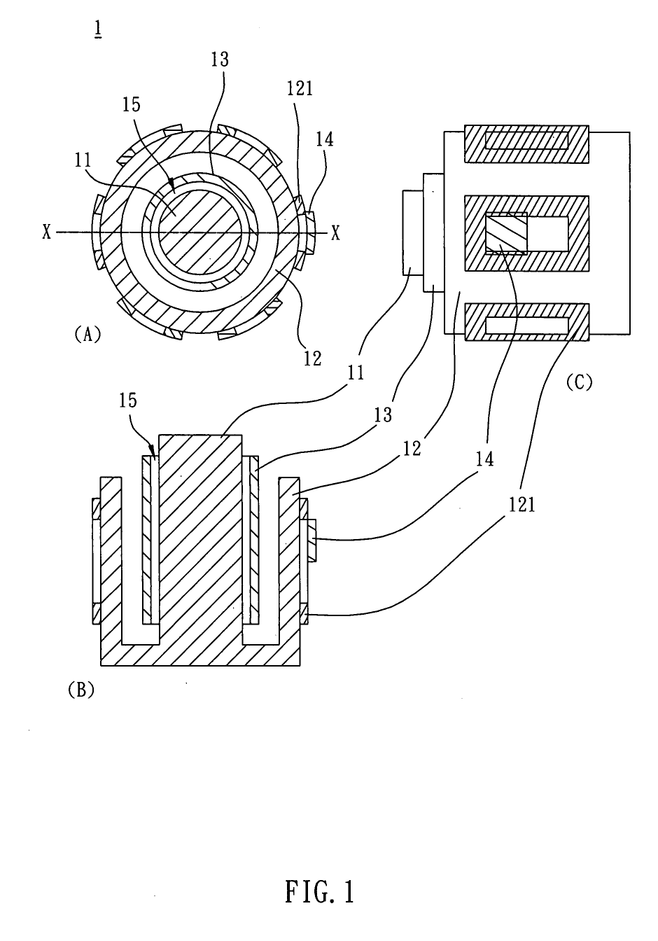

As shown in FIG. 1, a motor 1 according to a first embodiment of the invention includes a shaft 11, a stator 12, a rotor 13 and a magnetic body 14. The stator 12 includes a plurality of coils 121. The rotor 13 is disposed between the shaft 11 and the stator 12, and an air gap 15 is formed between the rotor 13 and the shaft 11. The magnetic body 14 is disposed to any one of the coils 121. In the embodiment, the magnetic body 14 can be a permanent magnet, such as a magnet, a magnetite or a magnetic yoke. Alternatively, the magnetic body 14 can be a silicon steel sheet or a soft magnet made of iron, cobalt, nickel or alloys thereof. In more detail, the rotor 13, the shaft 11 and air gap 15 therebetween constitutes the air bearing structure. In the air bearing structure, the shaft 11 is an inner circular part, and the rotor 13 is an outer circular part.

In the embodiment, due to the magnetic torque caused by the magnetic body 14, the rotor 13 is biased toward the magnetic body 14 when the motor 1 is operating. In this case, the distance between the shaft 11 and the rotor 13 located near the magnetic body 14 is larger than that opposite to the magnetic body 14. In other words, the air gap 15 at a place far away the magnetic body 14 is a little narrower than that near the magnetic body 14. Such a non-uniform air gap 15 can reduce the vibration of the shaft 11 when the rotor 13 is rotating.

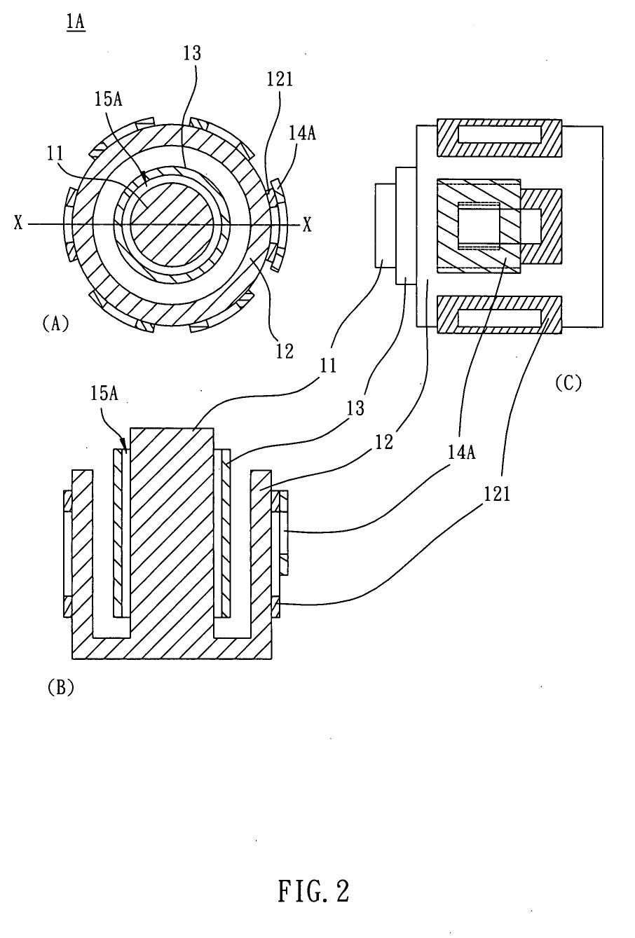

FIG. 2 shows a motor 1A according to a second embodiment of the invention. The structure of the motor 1A of the second embodiment is similar to those of the motor 1 of the first embodiment, so the detailed descriptions are omitted. To be noted, in the second embodiment, an air gap 15A is formed between the shaft 11 and the rotor 13, and a magnetic body 14A, which is an extra coil structure, is provided to substitute the magnet of the first embodiment. When the motor 1A is operating, the magnetic body 14A is applied with a current so as to generate a magnetic force for biasing the rotor 13 toward the magnetic body 14A. This magnetic force can also induce the non-uniformity of the air gap 15A. Therefore, the shaft 11 can be more stable and have less vibration when the rotor 13 is rotating.

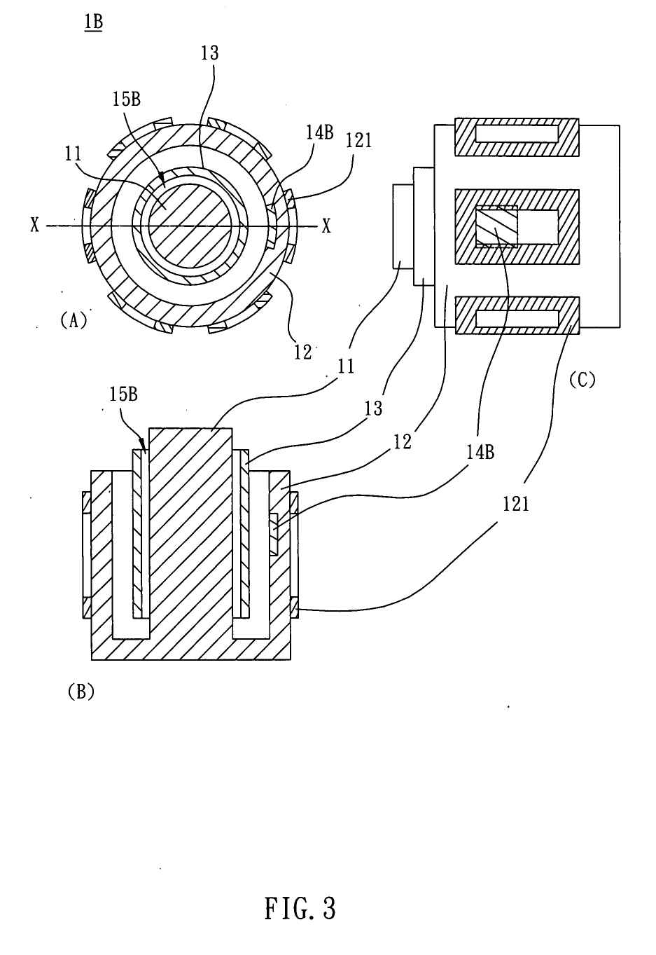

FIG. 3 shows a motor 1B according to a third embodiment of the invention. The structure of the motor 1B of the third embodiment is similar to those of the motor 1 of the first embodiment, so the detailed descriptions are omitted. To be noted, in the third embodiment, a magnetic body 14B is embedded on an inner surface of the stator 12. Thus, the rotor 13 can be biased toward the magnetic body 14B by a magnetic torque of the magnetic body 14B, causing the non-uniformity of the air gap 15B. Therefore, the shaft 11 can be more stable and have less vibration when the rotor 13 is rotating. In the embodiment, the magnetic body 14B is a permanent magnet such as a magnet, a magnetite or a magnetic yoke.

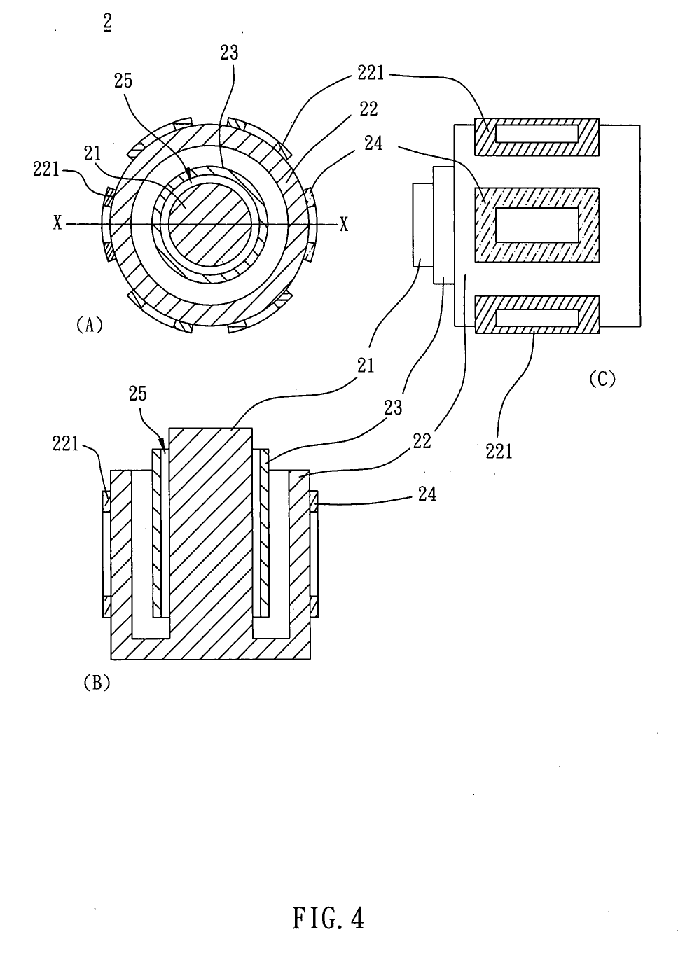

FIG. 4 shows a motor 2 according to a fourth embodiment of the invention. The motor 2 includes a shaft 21, a stator 22 and a rotor 23. The stator 22 includes a plurality of coils 221. The rotor 23 is disposed between the shaft 21 and the stator 22 so as to form an air gap 25 between the shaft 21 and the rotor 23. The shaft 21, rotor 23 and air gap 25 constitute an air bearing structure, while the shaft 21 is an inner circular part of the air bearing structure and the rotor 23 is an outer circular part.

In this embodiment, the magnetic body as described in the first, second or third embodiment is unnecessary. Herein, any one of the coils 221 has a winding number different from others. This configuration can make the magnetic torque become non-uniform around the stator 22. As shown in FIG. 4, the winding number of a coil 24 is different from that of other coils 221. If the winding number of the coil 24 is greater than that of the other coils 221, the rotor 23 will be biased toward the winding 24 by the magnetic force of the coil 24. In this case, the air gap 25 is larger at a place near the winding 24. Alternatively, if the winding number of the winding 24 is less than that of other coils 221, the rotor 23 will be biased away from the winding 24 by the magnetic force of the winding 24. In this case, the air gap 25 is smaller at the place near the winding 24. Therefore, the winding 24 can cause the non-uniformity of the air gap 25 between the shaft 21 and the rotor 23, so that the shaft 21 can be more stable and have less vibration when the rotor 23 is rotating.

The fourth embodiment of the invention is not restricted to change the winding number of a single coil. In practice, two adjacent coils, two coils separated by one of the other coils or three adjacent coils can have different winding number from each other to form the magnetic torque. Therefore, the non-uniformity of the air gap 25 between the shaft 21 and rotor 23 can be formed.

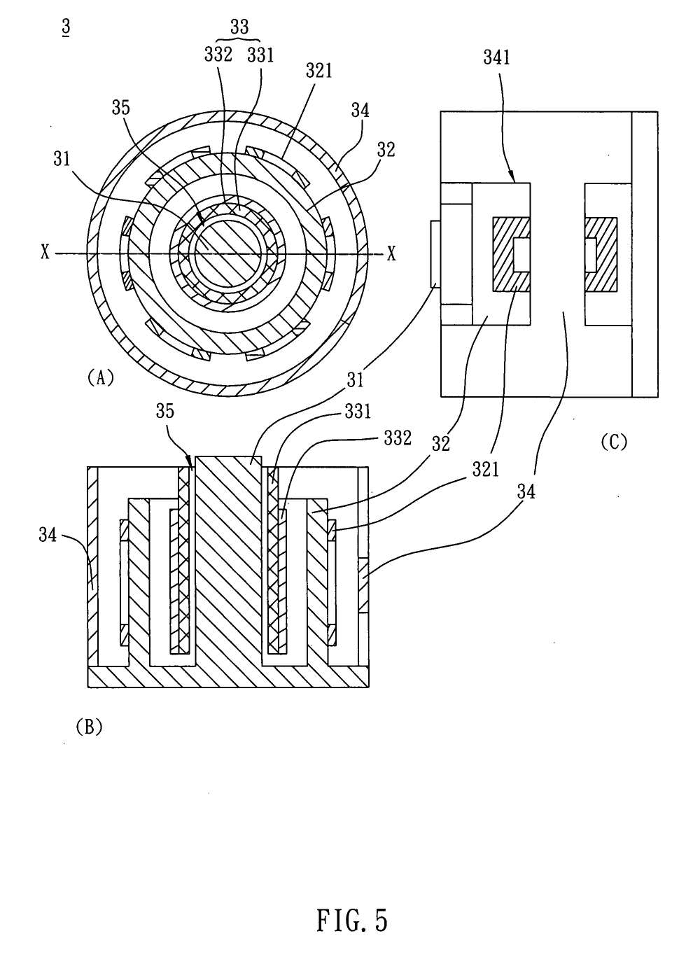

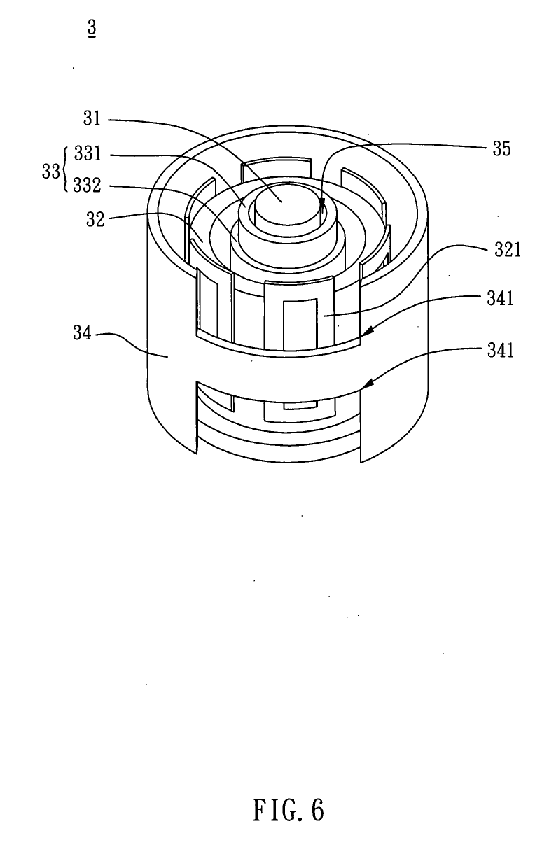

FIG. 5 shows a motor 3 according to a fifth embodiment of the invention. The motor 3 includes a shaft 31, a stator 32 and a rotor 33. The rotor 33 includes an outer ring portion 331 and a permanent magnet 332 disposed on the periphery of the outer ring portion 331. The rotor 33 is disposed between the shaft 31 and the stator 32 so that an air gap 35 is formed between the shaft 31 and the rotor 33. The shaft 31, rotor 33 and air gap 35 constitute an air bearing structure. The stator 32 includes a plurality of coils 321. In the embodiment, an iron ring 34 is disposed around the motor 3. The iron ring 34 can be made of yoke with two corresponding openings 341. The structure of the iron ring 34 will be more comprehensive with referring to FIG. 6.

In the embodiment, the openings 341 are located at two ends of the iron ring 41 and cause the non-uniform magnetic force of the iron ring 34 applied to the rotor 33 so that the rotor 33 can be biased away from the openings 341 when the motor 3 is operating. In other words, the air gap 35 at a place near the openings 341 is a little narrower than that at a place far away the openings 341. Such a non-uniform air gap 35 can reduce the vibration of the shaft 31 when the rotor 33 is rotating.

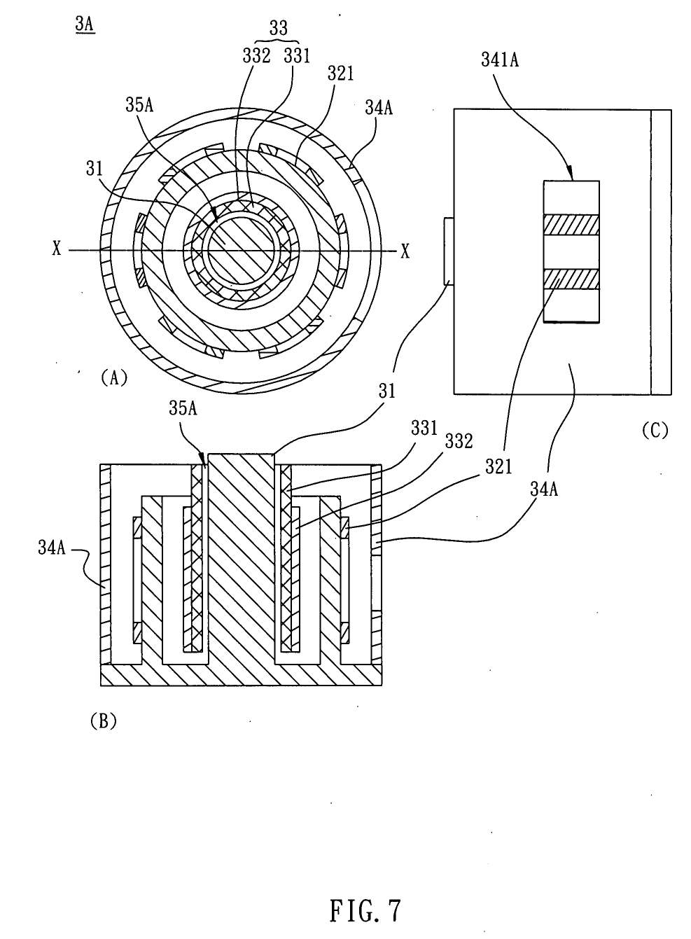

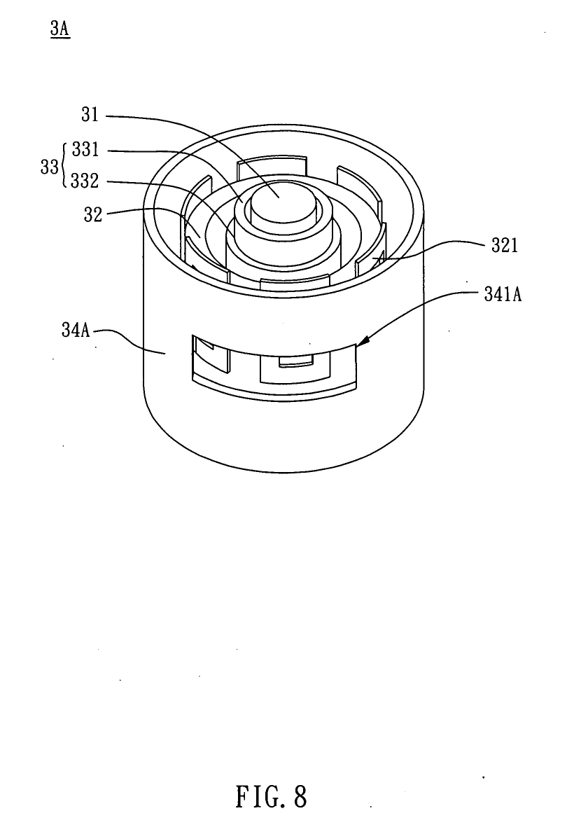

FIG. 7 shows a motor 3A according to a sixth embodiment of the invention. The structure of the motor 3A of the sixth embodiment is similar to that of the motor 3 of the fifth embodiment, so the detailed descriptions are omitted. To be noted, in the sixth embodiment, an air gap 35A is formed between the shaft 31 and the rotor 33, and the shaft 31, rotor 33 and air gap 35A construct an air bearing structure. In addition, an iron ring 34A, which is made of yoke and has an opening 341A located at the periphery thereof, is disposed around the motor 3A. The structure of the iron ring 34A with the opening 341A will be more comprehensive with referring to FIG. 8. In the embodiment, the opening 341A of the iron ring 34A is located at a center of the iron ring and causes the non-uniform magnetic torque applied to the rotor 33 so that the rotor 33 can be biased away from the opening 341A. In other words, the air gap 35A at a place near the opening 341A is a little narrower than that far away the opening 341A. Such a non-uniform air gap 35A can reduce the vibration of the shaft 31 when the rotor 33 is rotating.

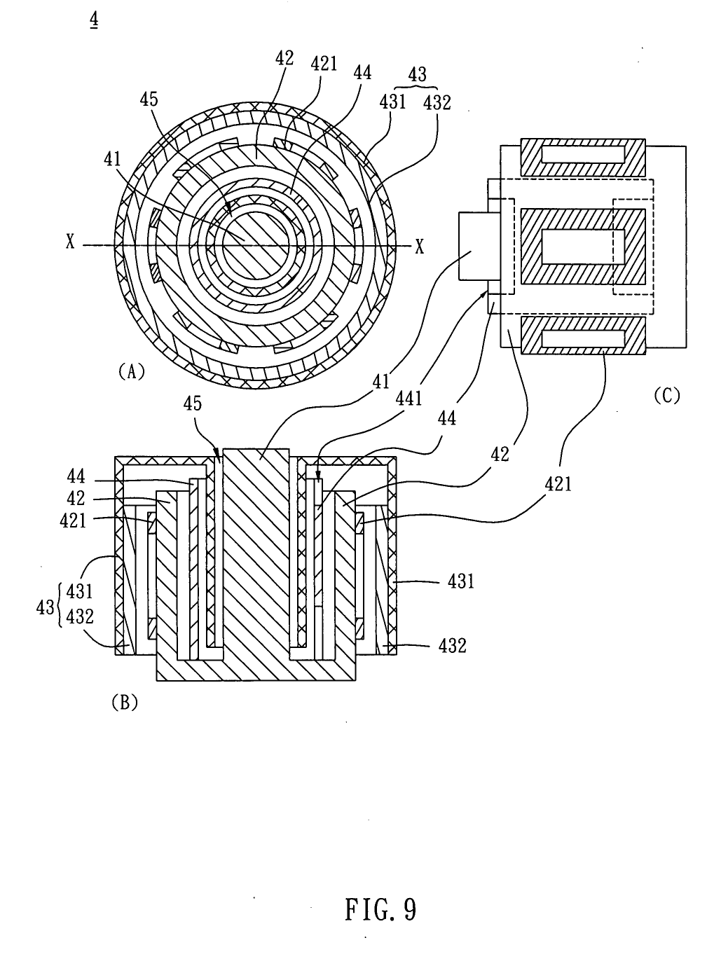

FIG. 9 shows a motor 4 according to a seventh embodiment of the invention. The motor 4 includes a shaft 41, a stator 42 and a rotor 43. The stator 42 includes a plurality of coils 421, and an iron ring 44 is disposed between the stator 42 and shaft 41. The rotor 43 includes an outer ring 431 and a permanent magnet 432. The outer ring 431 is annularly disposed between the shaft 41 and the iron ring 44 so as to form an air gap 45 between the outer ring 431 and the shaft 41. These elements construct an air bearing structure. The outer ring 431 is extended outwardly relative to the shaft 41, and the permanent magnet 432 is disposed corresponding to the coils 421. In the (C) part of FIG. 9, a lateral view of the motor 4, with omitting the rotor 43, the outer ring 431 and the permanent magnet 432, is illustrated.

In the embodiment, the iron ring 44 is made of yoke with two corresponding openings 441. That is, the openings 441 are located at two ends of the iron ring 44, respectively. Thus, the rotor 43 can be biased toward the openings 441 when the motor 4 is operating. In other words, the air gap 45 at a place near the openings 441 is a little larger than that far away the openings 441. Such a non-uniform air gap 45 can reduce the vibration of the shaft 41 when the rotor 43 is rotating.

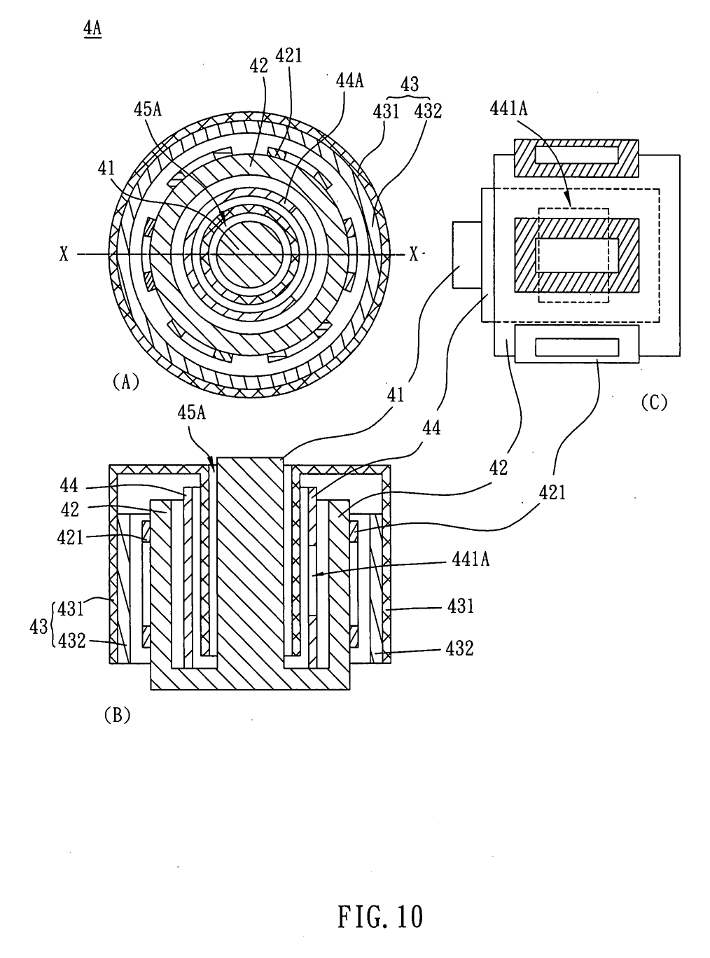

FIG. 10 shows a motor 4A according to an eighth embodiment of the invention. The structure of the motor 4A of the eighth embodiment is similar to those of the motor 4 of the seventh embodiment, so the detailed descriptions are omitted. To be noted, in the eighth embodiment, an iron ring 44A is disposed between the stator 42 and a center of the motor 4A. The rotor 43 includes an outer ring 431 and a permanent magnet 432. The outer ring 431 is annularly disposed between the shaft 41 and the iron ring 44A so as to form an air gap 45A between the outer ring 431 and the shaft 41. These elements construct an air bearing structure. The outer ring 431 is extended outwardly relative to the shaft 41, and the permanent magnet 432 is disposed corresponding to the coils 421. In the (C) part of FIG. 10, a lateral view of the motor 4A, with omitting the rotor 43, the outer ring 431 and the permanent magnet 432, is illustrated. In the embodiment, the iron ring 44A is made of yoke and has an opening 441A located at a center thereof. Thus, the rotor 43 can be biased toward the opening 441A when the motor 4A is operating. In other words, the air gap 45A at a place near the opening 441A is a little larger than that at a place farther away the opening 441A. Such a non-uniform air gap 45A can reduce the vibration of the shaft 41 when the rotor 43 is rotating.

In summary, the motor of the invention disposes permanent magnet or yoke close to the air bearing structure, or changes the winding numbers of coils of the stator to change the magnetic field. Thus, the air gap is non-uniform while the air bearing structure rotates so as to reduce the vibration. Compared with the prior art, the invention utilizes the magnetic body to change the distribution of the magnetic field in the motor for stabilizing the shaft. In other words, it is unnecessary to process the shaft to form the conventional grooves.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A motor comprising:
a shaft;
a stator having a plurality of coils;
a rotor disposed between the shaft and the stator so that an air gap is formed between the rotor and the shaft; and
a magnetic body disposed at the periphery of the stator.

2. The motor according to claim 1, wherein the magnetic body is disposed on any one of the coils.

3. The motor according to claim 2, wherein the magnetic body is a permanent magnet, a magnetite or a magnetic yoke.

4. The motor according to claim 2, wherein the magnetic body is a soft magnet.

5. The motor according to claim 4, wherein the soft magnet is made of iron, cobalt, nickel or alloys thereof.

6. The motor according to claim 2, wherein the magnetic body is a silicon steel sheet.

7. The motor according to claim 1, wherein the magnetic body is an extra coil provided on any one of the coils.

8. The motor according to claim 7, wherein the extra coil is applied with a current to generate a magnetic force.

9. The motor according to claim 1, wherein the magnetic body is embedded on an inner surface of the stator.

10. The motor according to claim 9, wherein the magnetic body is a magnet, a magnetite or a magnetic yoke.

11. A motor comprising:
a shaft;
a stator having a plurality of coils, wherein at least one of the coils has a winding number different from that of the other coils; and
a rotor disposed between the shaft and the stator so that an air gap is formed between the rotor and the shaft.

12. The motor according to claim 11, wherein the two adjacent coils have the winding numbers different from each other.

13. The motor according to claim 11, wherein two of the coils have the winding numbers different from each other, and are separated by one of the other coils.

14. The motor according to claim 11, wherein the adjacent three of the coils have the winding numbers different from others.

15. A motor comprising:
a shaft;
a stator having a plurality of coils;
a rotor disposed between the shaft and the stator so that an air gap is formed between the rotor and the shaft; and
an iron ring disposed around the rotor or between the stator and the rotor, and having at least one opening.

16. The motor according to claim 15, wherein the opening is located at an end or a center of the iron ring.

17. The motor according to claim 15, wherein the iron ring is a yoke.

18. The motor according to claim 15, wherein the rotor has an extending portion extended away from the shaft, and a permanent magnet corresponding to the coils.
